(19) United States
(12) Patent Application Publication
(10) Pub. No.: US 2013/0152686 A1
(43) Pub. Date: Jun. 20, 2013

(54) System and Method of Reducing Noise in a MEMS Device

(71) Applicant: Srinivasan Venkatraman, Natick, MA (US)

(72) Inventor: Srinivasan Venkatraman, Natick, MA (US)

(73) Assignee: ANALOG DEVICES, INC., Norwood, MA (US)

(21) Appl. No.: 13/328,177

(22) Filed: Dec. 16, 2011

(51) Int. Cl. G01P 15/125

(52) U.S. Cl. 73/514.32

(57) ABSTRACT

A MEMS system has an input for receiving a plurality of frequency division multiplexed variable capacitance signals, and a readout node electrically coupled with the input. Each variable capacitance signal is produced by a variable capacitor and has data relating to movement of microstructure associated with that variable capacitor. Moreover, each variable capacitance signal is produced by a variable capacitor that is different from the variable capacitor producing any of the other variable capacitance signals. The system further has a mixer electrically coupled with the readout node, and an output electrically coupled with the mixer. The mixer is configured to substantially continuously receive the plural variable capacitance signals. In addition, the output has an output interface for delivering the plurality of variable capacitance signals in parallel. The signals at the output should represent real time signals, as compared to stale sample and hold signals used in prior art systems.

### RELATED APPLICATION

This patent application is related to U.S. patent application Ser. No. ______, filed on even date herewith, entitled, “LOW NOISE AMPLIFIER FOR MULTIPLE CHANNELS,” and naming Howard Samuels as inventor, the disclosure of which is incorporated herein, in its entirety, by reference.

### TECHNICAL FIELD

The invention generally relates to MEMS devices and, more particularly, the invention relates to improving the signal to noise ratio in a MEMS device.

### BACKGROUND ART

Microelectromechanical systems (“MEMS”) are used in a growing number of applications. For example, MEMS currently are implemented as gyroscopes for stability control systems in automobiles, as microphones in acoustic systems, and as accelerometers to selectively deploy air bags in automobiles. In simplified terms, such MEMS devices typically have a structure suspended above a substrate, and associated electronics that both senses movement of the suspended structure and delivers the sensed movement data to one or more external devices (e.g., an external computer). The external device processes the sensed data to calculate the property being measured (e.g., pitch angle, an incident acoustic signal, or acceleration).

In many applications, the suspended, movable mass may form a variable capacitor with a fixed electrode. Movement of the mass of, for example, an accelerometer, is represented by a variable capacitance signal the capacitor produces in response to actual acceleration. In multi-dimensional accelerometers, this can produce two or three respective capacitance signals—up to one for each dimension along a Cartesian coordinate system.

State of the art accelerometers use time division multiplexing techniques to forward those multiple variable capacitance signals toward the MEMS output. Time division multiplexing, however, produces aliasing noise, undesirably reducing the signal to noise ratio. Those in the art have responded to this problem by using MEMS devices that produce a sufficiently large signal to overcome the noise produced by this multiplexing technique. This typically requires a larger MEMS device, which often is more expensive, requires more power, and takes up more real estate.

### SUMMARY OF THE VARIOUS EMBODIMENTS

In accordance with one embodiment of the invention, a MEMS system has an input for receiving a plurality of frequency division multiplexed variable capacitance signals, and a readout node electrically coupled with the input. Each variable capacitance signal is produced by a variable capacitor and has data relating to movement of microstructure associated with that variable capacitor. Moreover, each variable capacitance signal is produced by a variable capacitor that is different from the variable capacitor producing any of the other variable capacitance signals. The system further has a mixer electrically coupled with the readout node, and an output electrically coupled with the mixer. The mixer is configured to substantially continuously receive the plural variable capacitance signals. In addition, the output has an output interface for delivering the plurality of variable capacitance signals in parallel. The signals at the output should represent real time signals, as compared to stale sample and hold signals used in prior art systems.

The system may have frequency division multiplexer for producing the plurality of variable capacitance signals. The frequency division multiplexer may produce the plurality of variable capacitance signals to be non-overlapping in frequency. To produce the plurality of variable capacitor signals, the system may have a plurality of variable capacitors that form an accelerometer.

The mixer may include a demodulator for demodulating at a demodulation frequency. In that case, the drive frequencies (driving the plurality of variable capacitance signals) are different than the demodulation frequency. The system also may have a plurality of filters electrically coupled with the mixer. This plurality of filters both filters and delivers each of the plurality of capacitance signals to the output interface.

Some embodiments have a first multiplex signal generator for generating a first multiplex signal at a first frequency, and a second multiplex signal generator for generating a second multiplex signal at a second frequency. These first and second multiplex signal generators may produce at least some of the plurality of variable capacitance signals. The first and second frequencies may be different, or they may be the same. Moreover, if the system has a demodulator demodulating signals at a demodulation frequency, the demodulation signal preferably is different than both the first and second frequencies.

In accordance with other embodiments, a MEMS device has a plurality of variable capacitors for producing a plurality of respective variable capacitor signals, and a frequency division multiplexer coupled with the plurality of variable capacitors. The multiplexer is configured to multiplex the plurality of variable capacitor signals to produce a plurality of multiplexed capacitance signals. The device also has a readout node electrically coupled with the multiplexer for receiving the plurality of frequency division multiplexed capacitance signals, and an output electrically coupled with the readout node. The output is configured to produce each of the capacitance signals in parallel (i.e., a plurality of signals having information in the capacitance signals).

In accordance with another embodiments, a method monitors movement of microstructure in a MEMS device having a first variable capacitor configured to produce a first capacitance signal relative to a first frame of reference, and a second variable capacitor configured to produce a second capacitance signal relative to a second frame of reference. The method thus modulates the first capacitance signal toward a readout node using a first frequency division multiplex signal, and modulates the second capacitance signal toward the same readout node using a second frequency division multiplex signal. The second capacitance signal is modulated at substantially the same time that the first capacitance signal is modulated toward the readout node. The first and second capacitance signals do not interfere with each other.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a cross-sectional view of a MEMS device that may implement illustrative embodiments of the invention.

FIG. 2 schematically shows a plan view of a portion of an accelerometer that may implement illustrative embodiments of the invention.

FIG. 3 schematically shows a circuit diagram of an accelerometer system implementing illustrative embodiments of the invention.

FIG. 4 shows a process of transmitting data through the accelerometer system shown in FIG. 3.

### DESCRIPTION OF ILLUSTRATIVE EMBODIMENTS

Illustrative embodiments substantially improve the signal-to-noise ratio of a variety of MEMS devices, such as two-axis or three-axis MEMS accelerometers. Accordingly, when implemented as discussed below, smaller MEMS devices can perform functions that currently require larger MEMS devices. This favorably enables use of smaller MEMS devices, thus reducing power and real estate requirements. Details of illustrative embodiments are discussed below.

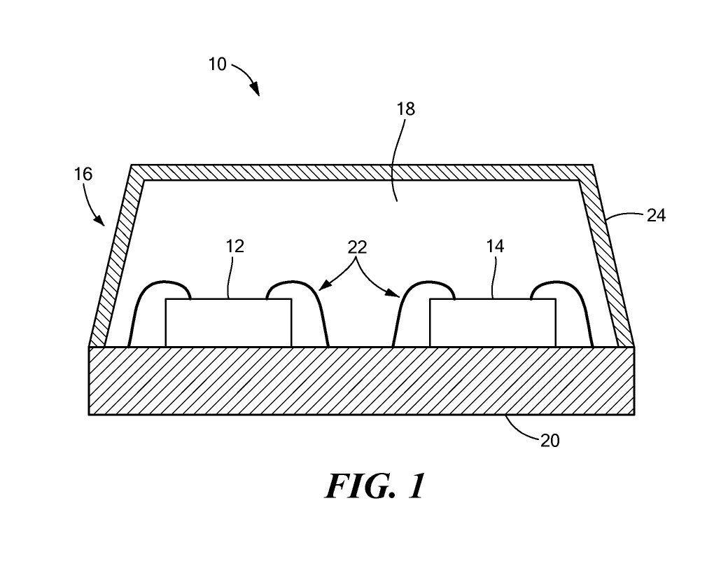

FIG. 1 schematically shows a cross-sectional view of a MEMS device 10 that may implement illustrative embodiments of the invention. Among other things, the MEMS device 10 implements an accelerometer system, which, as known by those skilled in the art, detects acceleration. For example, accelerometers are widely used in automobile safety control systems to deploy airbags in the event of a crash that causes a rapid negative acceleration. Specifically, upon receipt of an accelerometer signal indicating a rapid negative acceleration, the underlying safety system will substantially immediately deploy its airbags, protecting the occupants of the automobile.

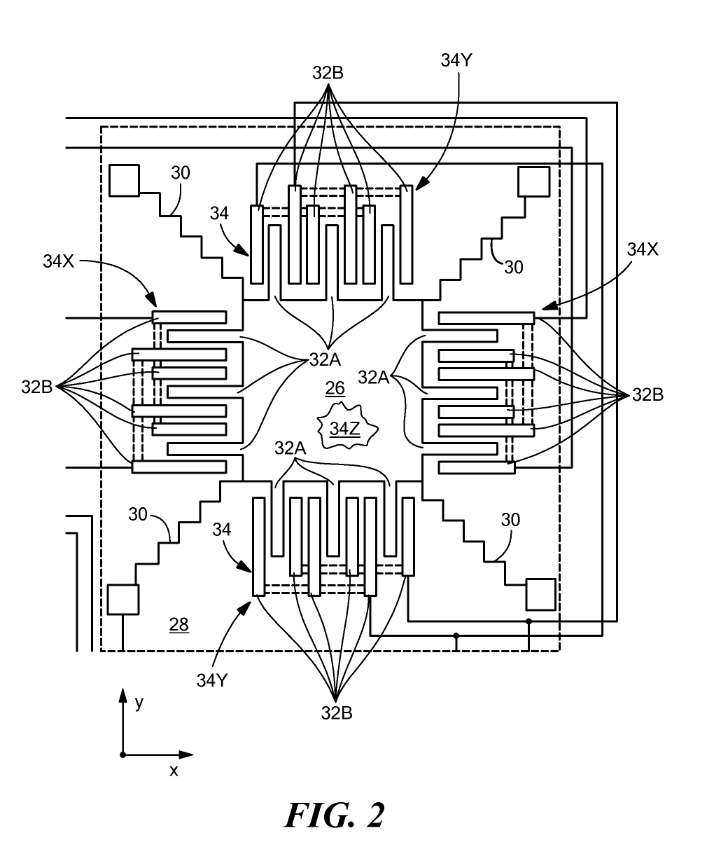

To those ends, the accelerometer has an accelerometer chip 12 with microstructure that moves in response to an acceleration (discussed in greater detail with respect to FIG. 2). To control its performance, this accelerometer chip 12 has electronic circuitry that is either on-chip with the microstructure or off-chip. As an example, FIG. 1 shows this circuitry in a separate application specific integrated circuit chip (referred to herein as “ASIC 14”) that electrically communicates with the accelerometer chip 12.

A conventional semiconductor package 16 encloses the accelerometer chip 12 and ASIC 14 within an internal chamber 18 that is substantially isolated from the external environment. The embodiment shown in FIG. 1 has a base 20 with internal electronic interconnections that electrically communicate the accelerometer chip 12 and ASIC 14 through conventional wirebonds 22. Pads (not shown) on the bottom surface of the base 20 of electrically communicate the accelerometer chip 12 and ASIC 14 with external system components, such as an underlying printed circuit board.

Any of a number of different packaging technologies should suffice. For example, among other things, the package 16 could incorporate a ceramic cavity package with a cover/lid, a substrate package having a cover, or a pre-molded or post molded leadframe package.

A lid 24 secured to the base 20 forms the internal chamber 18 for protecting and containing the accelerometer chip 12 and ASIC 14. Among other ways, the lid 24 may be secured to the base 20 using a heated glass frit or other conventional connecting process. Some embodiments may apply a ground potential to the lid 24 to prevent interference with the accelerometer chip 12. To further protect and facilitate accelerometer performance, the internal chamber 18 may be under a vacuum, or have an internal gas to provide squeeze film dampening for the accelerometer microstructure.

FIG. 2 schematically shows a plan view of the accelerometer chip 12 shown in FIG. 1. In simplified terms, as known by those skilled in the art, the accelerometer has a movable mass 26 suspended over a substrate 28 by a plurality of springs 30. The substrate 28 is fixedly secured to a surface, such as the base 20 of the package 16, while the mass 26 can move relative to the substrate 28 and the underlying surface. Accordingly, if in accelerometer moving at a substantially constant velocity suddenly stops, the movable mass 26 continues moving ahead in the same direction. As known by those in the art, this mass movement is related to the acceleration. The ASIC 14 or other circuitry electrically detects this movement, converting it into a data signal indicating the amount of acceleration.

The accelerometer shown in FIG. 2 has a single mass 26 suspended at each of its corners by four springs 30. Alternative embodiments may have plural masses. Illustrative embodiments form the springs 30 in a serpentine shape for optimum mass control. This accelerometer is capable of detecting accelerations along the three orthogonal axes; namely along the X-axis, the Y-axis, and the Z-axis. To that end, the mass 26 has a plurality of fingers 32A extending from each of its side surfaces. Each of these fingers 32A forms of differential, variable capacitor (generally identified by reference number “34”) with a pair of stationary fingers 32B secured to the substrate 28. It is these variable capacitors 34 that primarily “pick up” acceleration along the X-axis and the Y-axis. In other words, each mass finger 32A forms of first plate of a variable capacitor 34, while the stationary fingers 32B form stationary plates in the same variable capacitor 34. All of the variable capacitors 34 measuring acceleration in a single dimension thus effectively form a single variable capacitor 34. Fingers 32A and 32B configured in this manner are often referred to as being “interdigitated.”

The substrate 28 also has a single fixed electrode directly underneath the mass 26 to form a third variable capacitor 34Z (with the mass 26) that measures acceleration along the Z-axis (i.e., orthogonal to the X and Y axes, or, in other words, orthogonal to the faces of the movable mass 26). This third variable capacitor 34Z is shown schematically in a cut-away view of FIG. 2.

Since it detects acceleration in three dimensions, the MEMS system 10 is known in the art as a 3-axis accelerometer. Various embodiments, however, apply to accelerometers that detect acceleration in fewer than three dimensions, such as two-dimension accelerometers.

During operation, circuitry on the ASIC 14 energizes the capacitors 34. For example, the plates of the capacitors 34 may have a net voltage of zero when at rest. Movement of the mass 26 thus changes that voltage, generating a signal (e.g., a non-zero voltage) indicating an acceleration. To transmit signals from all three capacitors 34 across a single line, prior art designs known to the inventor apply a time division multiplex signal (“TDM signal”) to each of these capacitors 34 as they await and detect accelerations. One problem with using TDM signals, as noted above, is that they effectively sample signals, creating aliasing noise in the transmission line. Undesirably, this aliasing noise decreases the signal to noise ratio. Larger MEMS devices thus are required to overcome this noise penalty. Larger MEMS devices, however, are more costly and often less desirable.

To overcome this problem, the inventor discovered that application of substantially constant actuation signals to the variable capacitors 34, as well as substantially constant downstream processing (as discussed herein) mitigates this noise, thus enabling use of smaller accelerometers. More specifically, illustrative embodiments apply frequency division multiplex signals to the variable capacitors 34, thus permitting substantially constant information transmission across the single transmission line to the ASIC 14.

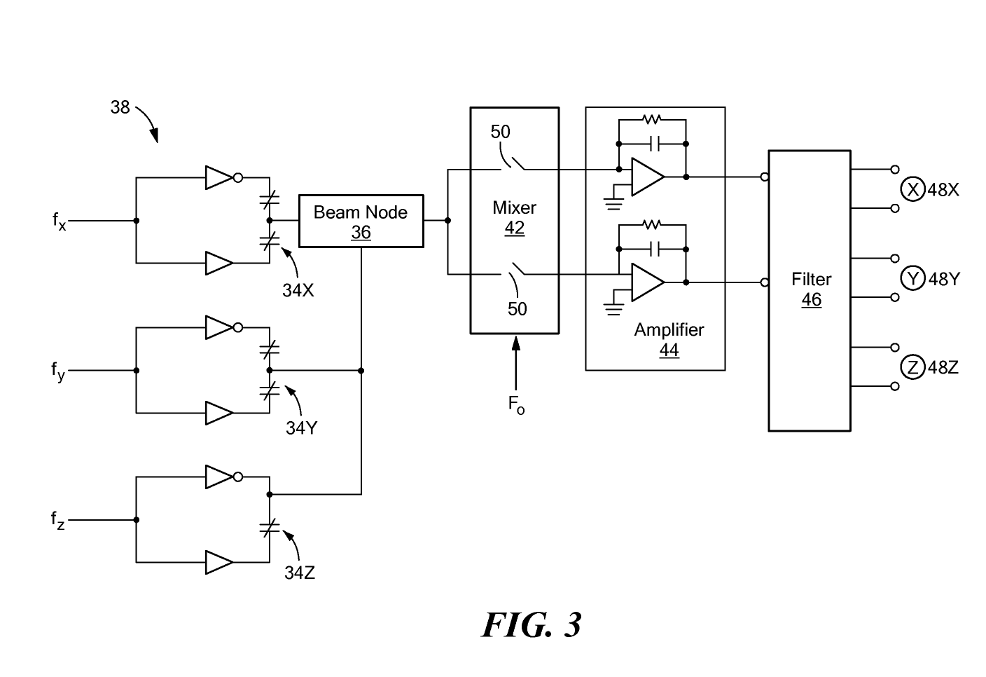

To that end, FIG. 3 schematically shows a circuit diagram of an accelerometer system/ MEMS device 10 implementing illustrative embodiments of the invention. As shown, three separate signals drive the three capacitors 34X, 34Y, and 34Z; namely, a first signal drives the X-axis capacitor 34X, a second signal drives the Y-axis capacitor 34Y, and a third signal drives the Z-axis capacitor 34Z. Each of these three signals may be a sine wave, square wave, or other periodic waveform having a frequency that is different from the other two signals. Accordingly, FIG. 3 represents these signals as signal Fx, signal Fy, and signal Fz. In illustrative embodiments, these three signals Fx, Fy, and Fz continuously energize their respective capacitors 34X, 34Y, and 34Z and thus, continuously direct signals across a single transmission line, shown as a “beam node 36” (also referred to as a “readout node 36”), and toward the circuitry resident primarily in the ASIC 14. This part of the circuit thus acts as a multiplexer 38. Since it is in a differential configuration, the multiplexer 38 also includes inverters/buffers to phase shift the incoming signals Fx, Fy, and Fz across the variable capacitors 34X, 34Y, and 34Z. It should be noted that those skilled in the art should be capable of modifying the described circuit to apply to single ended implementations.

The circuitry also includes a mixer 42 that demodulates the three frequency division multiplex signals, and an amplifier 44 that amplifies the signals to levels that are more readily processed. The amplifier 44 directs the signals to a low pass/band pass filter system 46 that, at its output, delivers the three capacitor signals at the same time across parallel output ports 48X, 48Y and 48Z. Unlike TDM systems, the output ports 48X, 48Y, and 48Z deliver three output signals that are continuous and substantially instantaneously accurate—there is no inherent delay, such as the delay required by the serial transmission processes used by TDM processes. This additional benefit therefore provides more up-to-date and accurate acceleration information.

It should be noted that these three output signals may be the exact variable capacitor signals (e.g., other circuitry not shown could produce the exact signal), or processed versions of the variable capacitor signals. In either case, unless explicitly stated otherwise, variable capacitor signals delivered by these output ports 48X, 48Y, and 48Z may be simply referred to as “variable capacitor signals” or “variable capacitance signals” produced by the variable capacitors 34X, 34Y, and 34Z.

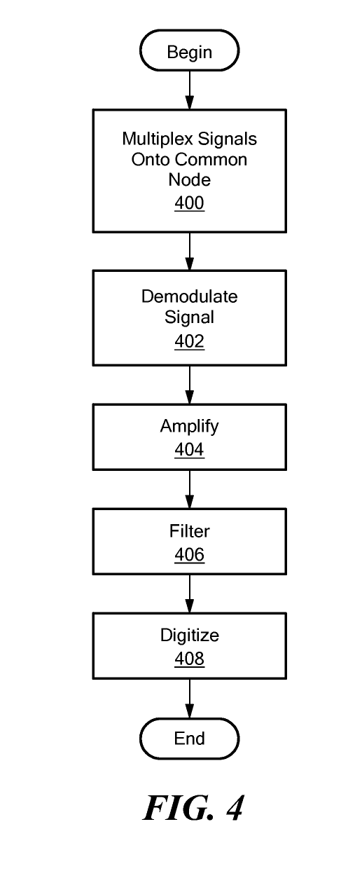

FIG. 4 shows a process of transmitting data through the accelerometer system shown in FIG. 3. The process begins at step 400, in which the multiplexers 38 (shown only as signals Fx, Fy, and Fz) multiplex the variable capacitor signals onto the common node, i.e., onto the beam node 36. To that end, the three signals Fx, Fy, and Fz all energize the plates of their respective capacitors 34X, 34Y, and 34Z, which directs them all onto the single beam node 36.

Next, step 402 demodulates the signals received from the beam node 36. To that end, the mixer 42 has a pair of switches 50 driven 180 degrees out of phase with each other by a signal Fo. In illustrative embodiments, signal Fo has is an oscillating signal having a different frequency than those of the signals Fx, Fy, and Fz. FIG. 4 schematically shows that signal as Fo.

It should be noted that the signal strength available for the accelerometer generally is proportional to the frequencies of signals Fx, Fy, and Fz. Those frequencies therefore can be selected as a function of the desired output signal strength. Accordingly, the signals Fx, Fy, and Fz can be set relatively high to provide a stronger signal. Of course, this comes with the penalty of causing the accelerometer to consume more power. After the mixer 42, however, the post-mixer signals for the channels used by signal Fx, signal Fy, and signal Fz should have frequencies as shown by the respective equations 1-3 below:

|Fx−Fo| (Equation 1)

|Fy−Fo| (Equation 2)

|Fz−Fo| (Equation 3)

The frequencies of the mixed signals (also referred to herein as “variable capacitor signals”) thus can still be relatively low by appropriate selection of frequency values. For example, the frequencies produced by Equations 1-3 can be lower than about 20 kilohertz. In addition, the signals Fx, Fy, and Fz preferably are non-overlapping in frequency and do not interfere with each other.

The system can generate the signals Fx, Fy, Fz, and Fo can using one or more clocks. For example, in one embodiment, all signals are driven by a single oscillator (not shown). To that end, signals Fx and Fy can be driven by the same frequency, but 90 degrees shifted from one another (i.e., they are orthogonal), while the other signals Fz and Fo are driven by the same oscillator but at different frequencies. For example, the oscillator may run at a frequency of 27.2 megahertz, while the Fx, Fy, Fz, and Fo signals are run at the following frequencies:

Fo=oscillator frequency/56=485.7 kilohertz,

Fx=Fy=oscillator frequency/58=468.96 kilohertz, and

Fz=oscillator frequency/55=494.55 kilohertz.

The signals Fx and Fy thus would be demodulated by Equation 1 as follows:

|Fx−Fo|=|oscillator frequency*(1/58−1/56)|=16.748 kilohertz,

While Fz would be demodulated by Equation 3 as follows:

|Fz−Fo|=|oscillator frequency*(1/55−1/56)|=8.831 kilohertz.

The process thus continues to step 404, in which the amplifier 44 amplifies the mixed signal, and then passes the amplified mixed signal to the filter system 46 (step 406). The filter system 46 preferably includes a low pass filter that filters out high frequency harmonics of the mixed signal. The filter system 46 also has a plurality of band pass filters that each delivers one of the variable capacitor signals to one of the parallel filter output ports 48X, 48Y, and 48Z. Specifically, as noted above, the filter output has three parallel ports: an X-axis port 48X, a Y-axis port 48Y, and a Z-axis port 48Z. Accordingly, one of the band pass filters removes the variable capacitor signals derived from the Y-axis capacitor 34Y and the Z-axis capacitor 34Z to leave the X-axis variable capacitor signal behind for the X-axis port 48X. Corresponding bandpass filters for the Y-axis port 48Y and Z-axis port 48Z perform corresponding filtering operations to respectively produce the Y-axis variable capacitor signal and Z-axis variable capacitor signal.

At this point, the variable capacitors signals at the three respective ports 48A, 48Y, and 48Z are in analog form. A wide variety of applications, however, digitize the signals for further processing by a logic device, such as a microprocessor within an airbag control system. Accordingly, step 408 digitizes the signals at the ports 48A, 48Y, and 48Z, thus concluding the process.

Indeed, accelerometer systems such as those discussed above certainly can benefit by implementing various embodiments of the invention. It should be noted, however, that discussion of an accelerometer system is but one example of many different types of MEMS devices that may benefit from implementing illustrative embodiments of the invention. For example, certain types of MEMS gyroscopes and pressure sensors, among other things, also may benefit from illustrative embodiments. Accordingly, discussion of accelerometers and specific types of accelerometers is for descriptive purposes only and not intended to limit various embodiments of the invention.

Some embodiments implement this process and arrangement for all dimensions—the X-axis, the Y-axis, and Z-axis sensing. Other embodiments, however, may implement this arrangement for fewer than all of the sensing axes. For example, some embodiments may apply frequency division multiplexing processes to only the X-axis and Y-axis signals.

Illustrative embodiments therefore favorably permit use of smaller accelerometer chips, thus reducing the overall size/footprint required within an underlying system (e.g., within an airbag control system). This also reduces power requirements since it uses smaller accelerometer chips than those required in prior art systems. Moreover, use of continuous signals, such as frequency division multiplex signals, provide substantially instantaneous, up-to-date information about the acceleration state of the body being measured—which is in direct contrast to prior art time division multiplex systems, where the data may be stale (e.g., for a three-axis accelerometer, a TDM system may read the acceleration data along a given dimension every third clock cycle).

Although the above discussion discloses various exemplary embodiments of the invention, it should be apparent that those skilled in the art can make various modifications that will achieve some of the advantages of the invention without departing from the true scope of the invention.

What is claimed is:

1. A MEMS system comprising:
an input for receiving a plurality of frequency division multiplexed variable capacitance signals, each variable capacitance signal being produced by a variable capacitor and having data relating to movement of microstructure associated with that variable capacitor, each variable capacitance signal being produced by a variable capacitor that is different from the variable capacitor producing any of the other variable capacitance signals;
a readout node electrically coupled with the input;
a mixer electrically coupled with the readout node, the mixer being configured to substantially continuously receive the plural variable capacitance signals; and
an output electrically coupled with the mixer, the output having an output interface for delivering the plurality of variable capacitance signals in parallel.

2. The MEMS system as defined by claim 1 further comprising a frequency division multiplexer for producing the plurality of variable capacitance signals.

3. The MEMS system as defined by claim 2 wherein the frequency division multiplexer produces the plurality of variable capacitance signals to be non-overlapping in frequency.

4. The system as defined by claim 1 further comprising:
a plurality of variable capacitors for producing the plurality of variable capacitance signals, the variable capacitors forming an accelerometer.

5. The MEMS system as defined by claim 1 wherein the mixer comprises a demodulator for demodulating at a demodulation frequency, the plurality of variable capacitance signals being driven by drive signals having drive frequencies, the drive frequencies being different than the demodulation frequency.

6. The MEMS system as defined by claim 1 further comprising a plurality of filters electrically coupled with the mixer, the plurality of filters filtering and delivering each of the plurality of capacitance signals to the output interface.

7. The MEMS system as defined by claim 1 wherein the mixer comprises a demodulator.

8. The MEMS system as defined by claim 1 further comprising:
a first multiplex signal generator for generating a first multiplex signal at a first frequency; and
a second multiplex signal generator for generating a second multiplex signal at a second frequency, the first frequency and second frequency being different,
the first and second multiplex signal generators producing at least some of the plurality of variable capacitance signals.

9. The MEMS system as defined by claim 8 wherein the mixer comprises a demodulator for demodulating signals at a demodulation frequency, the demodulation frequency being different from both the first and second frequencies.

10. The MEMS system as defined by claim 1 further comprising:
a first multiplex signal generator for generating a first multiplex signal at a first frequency; and
a second multiplex signal generator for generating a second multiplex signal at a second frequency, the first frequency and second frequency being the same but phase shifted relative to each other,
the first and second multiplex signal generators producing at least some of the plurality of variable capacitance signals.

11. A MEMS device comprising:
a plurality of variable capacitors for producing a plurality of respective variable capacitor signals;
a frequency division multiplexer coupled with the plurality of variable capacitors and being configured to multiplex the plurality of variable capacitor signals to produce a plurality of multiplexed capacitance signals;
a readout node electrically coupled with the multiplexer for receiving the plurality of frequency division multiplexed capacitance signals; and
an output electrically coupled with the readout node, the output being configured to produce each of the capacitance signals in parallel.

12. The MEMS system as defined by claim 11 wherein the plurality of variable capacitors and the output are on a single chip.

13. The MEMS system as defined by claim 11 wherein the plurality of variable capacitors and the output are on different chips.

14. The MEMS system as defined by claim 11 further comprising a package with an interior, the interior containing the plurality of variable capacitors and the output.

15. The MEMS system as defined by claim 11 further comprising a demodulator for demodulating a carrier signal carrying the multiplexed signals to produce the multiplexed signals, the demodulator configured to demodulate the carrier signal at a demodulate frequency, the multiplexed signals being multiplexed at a plurality of multiplex frequencies, the multiplex frequencies and demodulate frequency being different.

16. The MEMS system as defined by claim 15 wherein the multiplex frequencies are non-overlapping in frequency.

17. A method of monitoring movement of microstructure in a MEMS device, the MEMS device having a first variable capacitor configured to produce a first capacitance signal relative to a first frame of reference, and a second variable capacitor configured to produce a second capacitance signal relative to a second frame of reference, the method comprising:
modulating the first capacitance signal toward a readout node using a first frequency division multiplex signal; and
modulating the second capacitance signal toward the same readout node using a second frequency division multiplex signal, the second capacitance signal being modulated at substantially the same time that the first capacitance signal is modulated toward the readout node,
the first and second capacitance signals not interfering with each other.

18. The method as defined by claim 17 further comprising demodulating both signals at substantially the same time to produce a demodulated signal.

19. The method as defined by claim 18 wherein demodulating comprises demodulating at a demodulation frequency, the first frequency division multiplex signal having a first frequency, the second frequency division multiplex signal having a second frequency, the first and second frequencies being different from the demodulation frequency.

20. The method as defined by claim 18 further comprising:
filtering the demodulated signal to produce the first and second capacitive signals;
forwarding the first capacitive signal to a first interface; and
forwarding the second capacitive signal to a second interface,
the first and second interfaces being in parallel.
